(19) United States
(12) Patent Application Publication
(10) Pub. No.: US 2024/0054342 A1
(43) Pub. Date: Feb. 15, 2024

(54) DIMENSIONAL ATTENTION FOR WEIGHT ALLOCATION IN LANGUAGE MODELS OR OTHER MACHINE LEARNING MODELS

(71) Applicant: Samsung Electronics Co., Ltd., Suwon-si, Gyeonggi-do (KR)

(72) Inventors: Suhel Jaber, San Jose, CA (US); Brendon Christopher Beachy Eby, Chicago, IL (US); Sai Ajay Modukuri, San Francisco, CA (US)

(21) Appl. No.: 18/336,687

(22) Filed: Jun. 16, 2023

Related U.S. Application Data
(60) Provisional application No. 63/396,560, filed on Aug. 9, 2022.

(51) Int. Cl. G06N 3/08; G06N 3/048; G06N 3/0455

(52) U.S. Cl. CPC G06N 3/08; G06N 3/048; G06N 3/0455

(57) ABSTRACT

A method includes obtaining an input containing multiple tokens. The method also includes processing the input using a machine learning model. Processing the input includes performing attention over both (i) multiple dimensions of the tokens contained in the input and (ii) multiple dimensions of embedding vectors used to represent the tokens contained in the input so that different dimensions of each of at least some of the tokens are weighted differently. In addition, the method includes generating an output embedding vector for a query token of the multiple tokens based on the attention.

### CROSS-REFERENCE TO RELATED APPLICATION AND PRIORITY CLAIM

This application claims priority under 35 U.S.C. § 119(e) to U.S. Provisional Patent Application No. 63/396,560 filed on Aug. 9, 2022. This provisional application is hereby incorporated by reference in its entirety.

### TECHNICAL FIELD

This disclosure relates generally to machine learning systems. More specifically, this disclosure relates to dimensional attention for weight allocation in language models or other machine learning models.

### BACKGROUND

Various types of machine learning models have been developed over the years for use in natural language processing and other functions. One example type of machine learning model developed for natural language processing and other functions is the transformer model, which relies on the use of “self-attention.” Self-attention means that representations of words or other “tokens” in an input are determined by relating different tokens within the same input. An overall representation of the input may be further processed to perform natural language processing or other functions. Attention forms the backbone of many modern language models.

### SUMMARY

This disclosure relates to dimensional attention for weight allocation in language models or other machine learning models.

In a first embodiment, a method includes obtaining an input containing multiple tokens. The method also includes processing the input using a machine learning model. Processing the input includes performing attention over both (i) multiple dimensions of the tokens contained in the input and (ii) multiple dimensions of embedding vectors used to represent the tokens contained in the input so that different dimensions of each of at least some of the tokens are weighted differently. In addition, the method includes generating an output embedding vector for a query token of the multiple tokens based on the attention.

In a second embodiment, an electronic device includes at least one processing device configured to obtain an input containing multiple tokens. The at least one processing device is also configured to process the input using a machine learning model The machine learning model is configured to perform attention over both (i) multiple dimensions of the tokens contained in the input and (ii) multiple dimensions of embedding vectors used to represent the tokens contained in the input so that different dimensions of each of at least some of the tokens are weighted differently The at least one processing device is further configured to generate an output embedding vector for a query token of the multiple tokens based on the attention.

In a third embodiment, a non-transitory machine readable medium contains instructions that when executed cause at least one processor of an electronic device to obtain an input containing multiple tokens. The non-transitory machine readable medium also contains instructions that when executed cause the at least one processor to process the input using a machine learning model. The machine learning model is configured to perform attention over both (i) multiple dimensions of the tokens contained in the input and (ii) multiple dimensions of embedding vectors used to represent the tokens contained in the input so that different dimensions of each of at least some of the tokens are weighted differently. The non-transitory machine readable medium further contains instructions that when executed cause the at least one processor to generate an output embedding vector for a query token of the multiple tokens based on the attention.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular bead units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device according to this disclosure;

FIGS. 2A and 2B illustrate example transformer-based machine learning models supporting dimensional attention for weight allocation according to this disclosure;

FIGS. 3 through 5 illustrate example approaches for providing dimensional attention for weight allocation in language models or other machine learning models according to this disclosure;

FIG. 6 illustrates another example approach for providing dimensional attention for weight allocation in language models or other machine learning models according to this disclosure;

FIG. 7 illustrates yet another example approach for providing dimensional attention for weight allocation in language models or other machine learning models according to this disclosure; and

FIG. 8 illustrates an example method for providing dimensional attention for weight allocation in language models or other machine learning models according to this disclosure.

### DETAILED DESCRIPTION

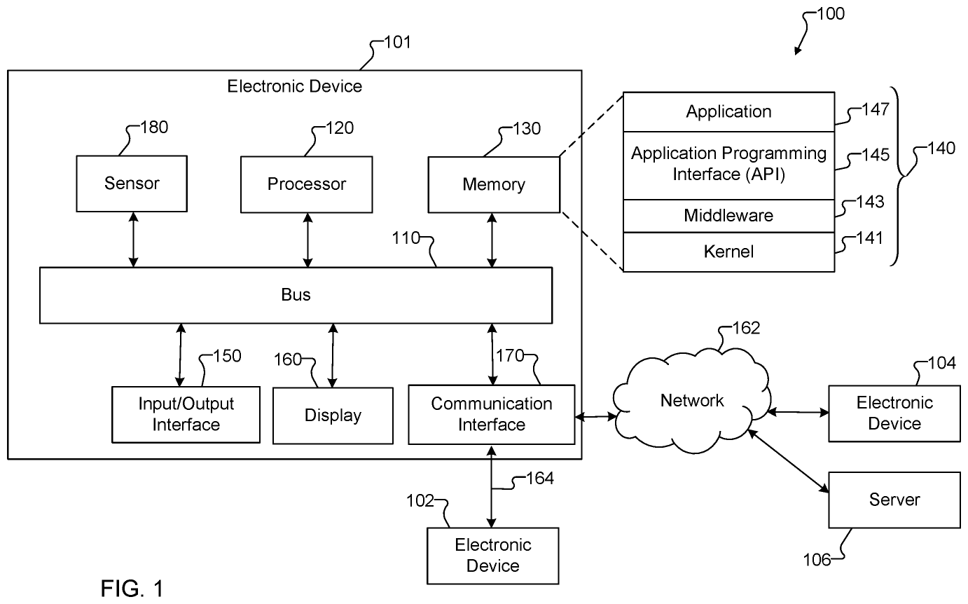

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As noted above, various types of machine learning models have been developed over the years for use in natural language processing and other functions. One example type of machine learning model developed for natural language processing and other functions is the transformer model, which relies on the use of “self-attention.” Self-attention means that representations of words or other “tokens” in an input are determined by relating different tokens within the same input. An overall representation of the input may be further processed to perform natural language processing or other functions. Attention forms the backbone of many modern language models.

Prior to performing attention, an input embedding is generated for each token contained in an input. For example, if the input is a natural language phrase, each token may represent a word or part of a word in the natural language phrase, and each token can be represented by an embedding vector. The primary motivation behind performing attention is that the meanings of words can depend on the meanings of other words in the natural language phrase. Based on how much each word in an input influences each other word in the input, a better embedding representation of the meaning for each specific word can be generated. In practice, the output embedding for each token generated using attention can be produced as a weighted average of the embeddings for all tokens. In this document, attention weights refer to weights that are applied to input embeddings in order to produce output embeddings during weighted combination.

As an example of this, assume that a sentence includes n tokens and that each token has m dimensions. The output embedding for token i ∈ {n} can be generated as the sum of the products produced by multiplying a weight for each token by an embedding representing that token. This weighted average is typically generated using three matrices, which are referred to as key (K), query (Q), and value (V) matrices. When generating the output embedding of token i, the weight wᵢⱼ that is used to represent the contribution of token j to the output embedding of token i can be expressed as follows.

wᵢⱼ=(tᵢ·Q)^{T}·(tⱼ·K) (1)

Here, tᵢ represents the input embedding of token i, tⱼ represents the input embedding of token j, ( )^{T} represents a transpose operation, and · represents a dot-product operation. In this example, (tᵢ·Q) can be said to represent a query representation, and (tⱼ·K) can be said to represent a key representation. The collection of weights wᵢⱼ (across all i and j values) can be scaled and activated with a softmax function to obtain a scalar weight w*ᵢⱼ for each token j being used to produce the output embedding for token i. The final output embedding Eᵢ for token i can therefore be generated in the following manner.

Eᵢ=Σⱼ(w*ᵢⱼ)^{T}·(tⱼ·V) (2)

In this example, (tⱼ·V) can be said to represent a value representation. The dimensions of K, Q, and V can be (m, d), where d is the dimensionality of the internal attention mechanism.

Attention performs well in many contexts. However, this approach provides a single weight for every token, so every dimension in each token is weighted equally. This is because the weights are created only at the token level, so every dimension gets sampled with the same distribution. This does not necessarily make sense linguistically since dimensions can represent different latent aspects of language, and it is conceivable that different words contribute in different ways for different latent representations of meaning. As an example, assume an input sentence contains the phrase “John ran quickly through the woods.” Also assume that one or more of the input dimensions encode a representation of how something is performed. When attempting to generate a weighted average to produce the output embedding for the token “ran,” these input dimensions might sample more heavily from the adjective in the sentence (“quickly”) as this modifies the action in the sentence (“ran”) and indicates whether the meaning of “ran” is a light jog or more of a full sprint. Further assume that one or more of the input dimensions encode a representation of when something occurs. Those input dimensions might sample more heavily from the location identified in the sentence (“in the woods”), which could imply a different kind of running than in other situations (such as when running on a track). Note that this is a simplistic example and that latent representations of tokens in a language model are typically far more complex. However, this does help to illustrate that there are likely situations in which generating attention weights on the token level alone is not sufficient.

This disclosure provides various techniques for dimensional attention for weight allocation in language models or other machine learning models. As described in more detail below, an input containing multiple tokens is obtained, such as when a natural language input or other input containing multiple words is obtained. Each token here may represent a word or a portion of a word contained in the input. The input is processed using a machine learning model, and the processing includes performing attention over both (i) multiple dimensions of the tokens contained in the input and (ii) multiple dimensions of embedding vectors used to represent the tokens contained in the input. This allows for the performance of dimensional attention when allocating attention weights used by the machine learning model. The results can include different dimensions of each of at least some of the tokens being weighted differently. An output embedding vector for a query token of the multiple tokens can be generated based on the attention. The output embedding vector for the query token may be used in any suitable manner, such as to perform a natural language processing function or other function.

Various approaches are described below for performing attention over the multiple dimensions of the tokens and over the multiple dimensions of the embedding vectors. For example, an additional dimension may be added to the query matrix Q, which allows for different query vectors for each embedding dimension. Also or alternatively, an additional dimension may be added to the key matrix K, which allows for different key vectors for each embedding dimension. It is also possible to add dimensions to all three Q, K, and V matrices, which may result in a more granular mixing of values at the dimensional level. As another example, instead of multiplying the Q and K matrices to generate attention weights for each token, feature-wise importance may be determined between the Q and K matrices, such as by using a dimension-level distance measure (like Euclidian distance, cosine similarity, or L1 distance), and the results can be used as or to produce the attention weights. As still another example, dimensional embedding may be added to or otherwise associated with the query representations, key representations, and value representations, where the dimensional embeddings identify dimensions associated with the tokens. As yet another example, separate attention operations may be performed to provide dimensional-level mixing and token-level mixing, which may or may not occur in parallel. Note that any suitable combination of these approaches may also be used. In whatever manner the attention is performed, the results may be subjected to a softmax operation in order to generate finalized weights that are used for combining value vectors for each token and thereby generate output embedding vectors. In some instances, output embedding vectors may be generated using various approaches described here within multiple attention heads, and the output embedding vectors generated by the multiple attention heads may be combined (such as via linear projection or pooling) to produce final output embedding vectors.

In this way, the described techniques support the use of attention performed over both the token dimension and the embedding dimension. This allows various dimensions to have a suitable distribution of weights when combining input tokens, which allows for more dynamic and complex combinations of meaning. This can lead to the creation of machine learning models that are more effective in terms of identifying user intents or performing other functions. In some embodiments, the described techniques may be used to create modified attention mechanisms to be used when training large language models (LLMs), such as those used by virtual assistants like BIXBY from SAMSUNG ELECTRONICS CO., LTD. As a particular example, the described techniques may be used in various transformer architectures, such as models that are constructed using architectures and pre-training regimes similar to those of GPT-3 or BERT. Note, however, that the described techniques may be used in any other suitable applications, such as in any other suitable use cases in which attention mechanisms are used. In the following discussion, it may often be assumed that the described techniques are implemented within or used by or with consumer electronic devices like smartphones or tablet computers. However, the described techniques may be implemented within or used by or with any other suitable portable electronic devices or other electronic devices, which in some cases may include servers or other components that communicate with consumer electronic devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 can perform one or more functions related to providing dimensional attention for weight allocation in a language model or other machine learning model.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 includes one or more applications for providing dimensional attention for weight allocation in a language model or other machine learning model. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The electronic device 101 further includes one or more sensors 180 that can meter a physical quantity or detect an activation state of the electronic device 101 and convert metered or detected information into an electrical signal. For example, one or more sensors 180 may include one or more cameras or other imaging sensors, which may be used to capture images of scenes. The one or more sensors 180 may also include one or more microphones or other audio sensors, which may be used to capture audio data. The sensor(s) 180 may further include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can also include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some cases, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 includes at least one communication network, such as a computer network (like a local area network (LAN) or wide area network (WAN)), Internet, or a telephone network.

The first and second external electronic devices 102 and 104 and server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. In some cases, the server 106 can perform one or more functions related to providing dimensional attention for weight allocation in a language model or other machine learning model.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

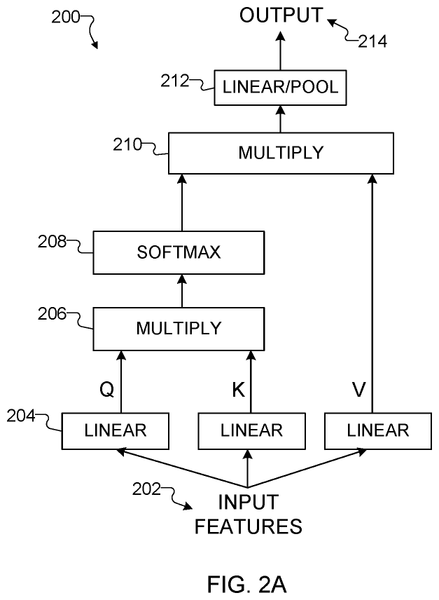

FIGS. 2A and 2B illustrate example transformer-based machine learning models 200 and 250 supporting dimensional attention for weight allocation according to this disclosure. For ease of explanation, the machine learning models 200 and 250 shown in FIGS. 2A and 2B are described as being implemented on or supported by the electronic device 101 in the network configuration 100 of FIG. 1. However, the machine learning models 200 and 250 shown in FIGS. 2A and 2B could be used with any other suitable device(s), such as the server 106, and in any other suitable system(s).

As shown in FIG. 2A, the machine learning model 200 represents a transformer-based model and includes a self-attention section, which is typically the core component of any transformer-based architecture. In this example, the machine learning model 200 receives input features 202, which represent features of the input data being processed by the machine learning model 200 (such as a natural language input). For example, the features may represent features that are generated by a feature extractor based on the input data, and the features may represent, include, or be based on tokens contained in the input data. Linear projections 204 are performed to generate query, key, and value matrices based on the input features 202. For instance, the linear projections 204 may multiply projections of the same input features 202 with different weight matrices (one weight matrix for the query matrix, one weight matrix for the key matrix, and one weight matrix for the value matrix). In general, each query matrix Q) is a matrix representation of a query token, and each key matrix Q is a matrix representation of a target token.

A multiplication function 206 multiplies the query and key matrices in order to produce attention weight vectors. A softmax function 208 is applied to the attention weight vectors in order to generate modified attention weight vectors. A multiplication function 210 multiplies the value matrix with the modified attention weight vectors, and a linear projection or pooling function 212 combines the results in order to produce a final output 214 of the transformer. The final output 214 can represent an output embedding vector associated with the input features 202.

As shown in FIG. 2B, the machine learning model 250 represents a transformer-based model and includes a multi-headed self-attention section. In this example, the machine learning model 250 receives input features 252, which represent features of the input data being processed by the machine learning model 250 (such as a natural language input). For example, the features may represent features that are generated by a feature extractor based on the input data, and the features may represent, include, or be based on tokens contained in the input data. Multiple linear projections 254 are performed to generate multiple query matrices, multiple key matrices, and multiple value matrices based on the input features 252. For instance, the linear projections 254 may multiply projections of the same input features 252 with different weight matrices (different weight matrices for the query matrix, different weight matrices for the key matrix, and different weight matrices for the value matrix). Multiple scaled dot-product attention layers 256 can each implement the functions 206-212 shown in FIG. 2A and described above. Each scaled dot-product attention layer 256 operates using a different one of the query matrices, a different one of the key matrices, and a different one of the value matrices. Each of the scaled dot-product attention layers 256 is associated with or represents a different attention head, where each attention head can be used to extract information from different representation subspaces and where different attention heads are associated with different projection matrices. As a result, each attention head can generate a different output embedding vector corresponding to the input features 252. A concatenation layer 258 combines the output embedding vectors generated by the different attention heads, and a linear projection or pooling function 260 processes the concatenated output embedding vectors (such as via multiplication with a weight matrix) in order to produce a final output 262 of the transformer. For instance, if pooling is used, the concatenated output embedding vectors may be pooled along the embedding dimension in order to produce the final output 262 of the transformer. The final output 262 can represent an output embedding vector associated with the input features 252.

As described in more detail below, various operations shown in FIGS. 2A and 2B can be configured to use one or more techniques for providing dimensional attention for weight allocation. For example, these techniques may be used in FIG. 2A to control how attention weight vectors are generated or applied using various ones of the functions 206-212 in the transformer-based machine learning model 200. Also, in some cases, these techniques may be used in multiple attention heads via suitable configurations of various ones of the functions 206-212 of each of the scaled dot-product attention layers 256 in the transformer-based machine learning model 250.

Although FIGS. 2A and 2B illustrate examples of transformer-based machine learning models 200 and 250 supporting dimensional attention for weight allocation, various changes may be made to FIGS. 2A and 2B. For example, dimensional attention for weight allocation may be used with any other suitable machine learning model that relies upon or that performs self-attention or other attention-related operations.

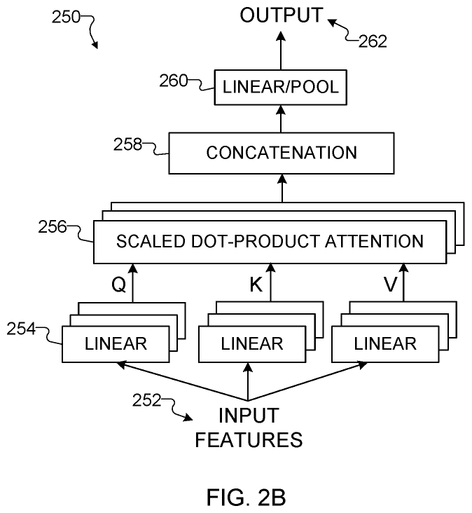

FIGS. 3 through 5 illustrate example approaches for providing dimensional attention for weight allocation in language models or other machine learning models according to this disclosure. For example, FIGS. 3 through 5 illustrate specific examples for providing dimensional attention that may be implemented using various ones of the functions 206-212 shown in FIG. 2A. In some cases, these approaches for providing dimensional attention may be used within a single attention head (such as the one shown in FIG. 2A) or in multiple attention heads (such as the ones shown in FIG. 2B).

As shown in FIG. 3, one approach 300 for providing dimensional attention for weight allocation supports the use of embedding-wise attention by expanding the dimensions of the query matrix Q. In this example, a query matrix 302, a key matrix 304, and a value matrix 306 are shown. The key matrix 304 and the value matrix 306 may be generated by the corresponding linear projections 204, 254 described above. The query matrix 302 may also be generated by the corresponding linear projection 204, 254 described above. However, unlike traditional approaches, the query matrix 302 here represents a three-dimensional matrix (rather than a two-dimensional matrix). The generation of the query matrix 302 can be achieved by having the corresponding linear projection 204, 254 add a dimension equivalent to the number of internal dimensions d to the query matrix 302. This causes the query matrix 302 to become a three-dimensional tensor with dimensions of (m, d, d), which essentially provides a separate m×d matrix for each dimension.

Each input embedding 308 (tᵢ) for a token i being processed here can be multiplied by the query matrix 302 to produce multiple vectors 310, multiplied by the key matrix 304 to produce a vector 312, and multiplied by the value matrix 306 to produce a vector 314. A weight vector 316 (denoted Wᵢⱼ) can be generated and used to represent the contribution of another token j to the output embedding of token i. Here, the weight vector 316 represents a collection of weights rather than a single scalar weight. This indicates that suitable weights can be determined for different dimensions of the embeddings rather than a single uniform weight. In some embodiments, the weight vector 316 represents a d×1 vector of weights.

In this approach, a dimension equivalent to the number of internal dimensions d is added to the query matrix 302, and weight vectors Wᵢⱼ are used to produce weighted combinations of embeddings (rather than using scalar weights wᵢⱼ as described above). In these embodiments, when generating the output embedding of token i, the weight vector Wᵢⱼ that is used to represent the contribution of token j to the output embedding of token i can be expressed as follows.

Wᵢⱼ=(tᵢ·Q)^{T}·(tⱼ·K) (3)

The collection of weight vectors Wᵢⱼ (across all i and j values) can be scaled and activated with a softmax function to obtain adjusted weight vectors W*ᵢⱼ for each token j being used to produce the output embedding for token i. In some cases, this can be expressed as follows.

$${W}_{ij}^{*} = {softmax}_{d} ( \frac{{W}_{ij}}{\sqrt{d}} ) \qquad ( 4 )$$

This results in the generation of finalized weight vectors W*ᵢⱼ, which include weights normalized along each dimension. The final output embedding Eᵢ for token i can therefore be generated in the following manner.

Eᵢ=Σⱼ(W*ᵢⱼ)^{T}·(tⱼ·V) (5)

The final output embedding Eᵢ for token i can be used in any suitable manner, such as when the final output embedding Eᵢ is provided a subsequent layer in the language model or other machine learning model.

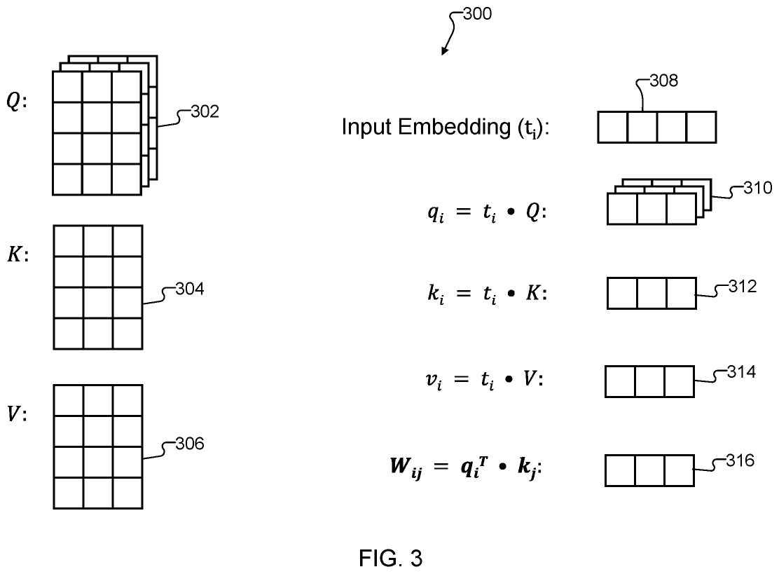

As shown in FIG. 4, another approach 400 for providing dimensional attention for weight allocation supports the use of embedding-wise attention by expanding the dimensions of the key matrix K. In this example, a query matrix 402, a key matrix 404, and a value matrix 406 are shown. The query matrix 402 and the value matrix 406 may be generated by the corresponding linear projections 204, 254 described above. The key matrix 404 may also be generated by the corresponding linear projection 204, 254 described above. However, unlike traditional approaches, the key matrix 404 here represents a three-dimensional matrix (rather than a two-dimensional matrix). The generation of the key matrix 404 can be achieved by having the corresponding linear projection 204, 254 add a dimension equivalent to the number of internal dimensions d to the key matrix 404. This causes the key matrix 404 to become a three-dimensional tensor with dimensions of (m, d, d), which essentially provides a separate mxd matrix for each dimension.

Each input embedding 408 (tᵢ) for a token i being processed here can be multiplied by the query matrix 402 to produce a vector 410, multiplied by the key matrix 404 to produce multiple vectors 412, and multiplied by the value matrix 406 to produce a vector 414. A weight vector 416 (Wᵢⱼ) can be generated and used to represent the contribution of another token j to the output embedding of token i. Again, the weight vector 416 represents a collection of weights rather than a single scalar weight, which indicates that suitable weights can be determined for different dimensions of the embeddings rather than a single uniform weight. In some embodiments, the weight vector 416 represents a d×1 vector of weights. Equations (3)-(5) or suitably-modified versions thereof may be used here to calculate and use the weight vectors Wᵢⱼ.

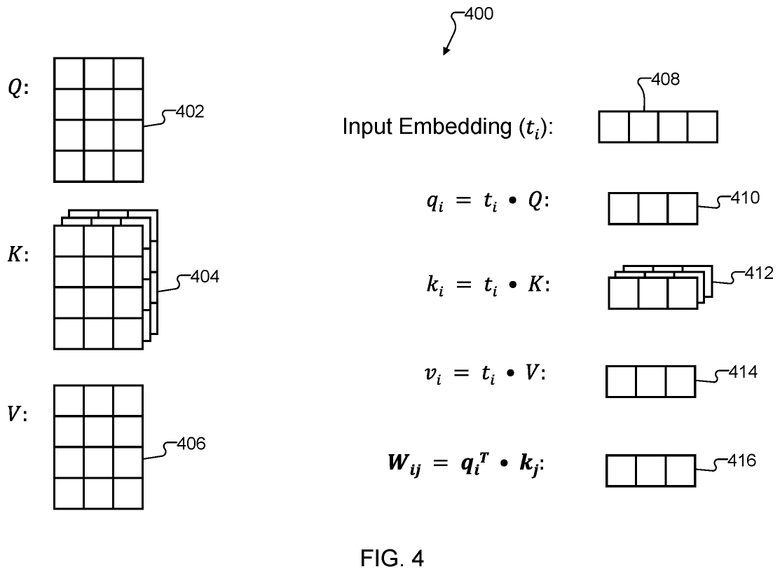

As shown in FIG. 5, yet another approach 500 for providing dimensional attention for weight allocation supports the use of embedding-wise attention by expanding the dimensions of the query matrix Q, the key matrix K, and the value matrix V. In this example, a query matrix 502, a key matrix 504, and a value matrix 506 are shown. The query matrix 502, key matrix 504, and value matrix 506 may be generated by the corresponding linear projections 204, 254 described above. However, unlike traditional approaches, each matrix 502, 504, 506 here represents a three-dimensional matrix (rather than a two-dimensional matrix). The generation of these matrices 502, 504, 506 can be achieved by having the corresponding linear projections 204, 254 add a dimension equivalent to the number of internal dimensions d to each matrix 502, 504, 506. This causes each matrix 502, 504, 506 to become a three-dimensional tensor with dimensions of (m, d, d), which essentially provides a separate m×d matrix for each dimension.

Each input embedding 508 (tᵢ) for a token i being processed here can by multiplied by the query matrix 502 to produce multiple vectors 510, multiplied by the key matrix 504 to produce multiple vectors 512, and multiplied by the value matrix 506 to produce multiple vectors 514. A weight vector 516 (Wᵢⱼ) can be generated and used to represent the contribution of another token j to the output embedding of token i. Again, the weight vector 516 represents a collection of weights rather than a single scalar weight, which indicates that suitable weights can be determined for different dimensions of the embeddings rather than a single uniform weight. Here, attention can be performed to generate results having (m, d, d) dimensions, and the results can be projected through a linear layer (such as the linear projection or pooling function 212) to produce results having (m, d) dimensions.

The approaches 300, 400, 500 shown in FIGS. 3 through 5 illustrate examples of how at least one extra dimension may be added to one or more of the query, key, and value matrices when generating attention weights to be applied to input embeddings. In all three of these approaches 300, 400, 500, this results in the generation of weight vectors Wᵢⱼ instead of standard scalar weights wᵢⱼ. The weight vectors Wᵢⱼ allow for appropriate weightings to be used across different dimensions of the input embeddings. After performing a softmax operation along each dimension of the weight vectors Wᵢⱼ to generate the finalized weight vectors W*ᵢⱼ, the finalized weight vectors W*ᵢⱼ are used with the value matrix to calculate the output embedding for each token. Among other things, this allows for the generation and use of different weighted averages for different dimensions of the tokens, which allows for the generation of output embeddings that pull differently from each dimension in each input token.

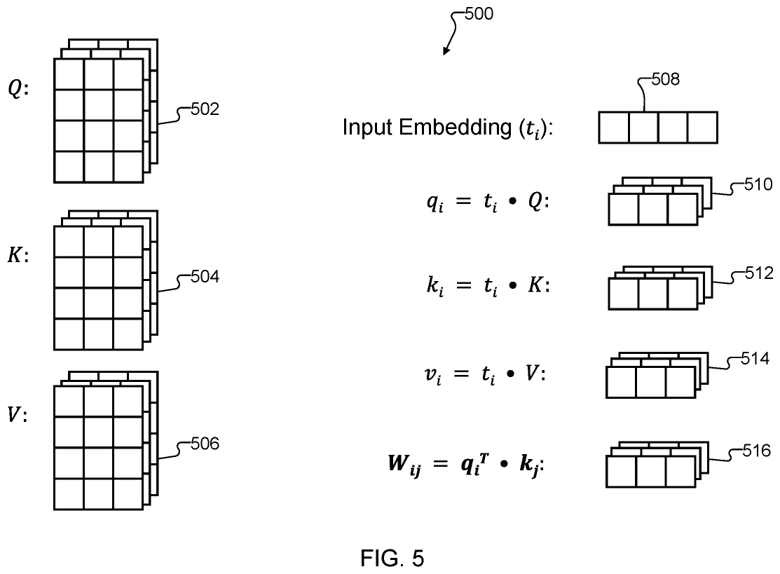

FIG. 6 illustrates another example approach 600 for providing dimensional attention for weight allocation in language models or other machine learning models according to this disclosure. For example, FIG. 6 illustrates a specific example for providing dimensional attention that may be implemented using various ones of the functions 206-212 shown in FIG. 2A. In some cases, this approach for providing dimensional attention may be used within a single attention head (such as the one shown in FIG. 2A) or in multiple attention heads (such as the ones shown in FIG. 2B).

It is generally known that calculation of attention weights can involve multiplying the query matrix Q and the key matrix K to generate the attention weights per token. The approach 600 uses a different technique for using the query matrix Q and the key matrix K. As shown in FIG. 6, a dimension-level distance measure is used to identify the attention weights per token. In this example, a query representation 602 and multiple key representations 604a-604n are illustrated, where each representation 602, 604a-604n includes a number of dimensions. While five dimensions are shown here, this is for illustration only, and each query representation 602 and each key representation 604a-604n may include any suitable number of dimensions (and typically a very large number of dimensions). The query representation 602 may be generated by taking the dot product of an input embedding for a query token and the query matrix Q, and the key representations 604a-604n may be generated by taking dot products of the input embeddings for various target tokens and the key matrix K.

In this approach, a matrix of attention weight vectors can be generated by calculating the distances between the entries in the query representation 602 to the entries in cach key representation 604a-604n. These distances may be expressed in any suitable manner, such as by using Euclidian distance, cosine similarity, or L1 distance. These dimension-level distance calculations may be used to generate an (m, d, d) matrix containing attention weights. Similar operations described above with respect to FIG. 3 may be used to generate final output embeddings for tokens based on these attention weights. In this example, the distance operations may be represented across m tokens, where each token m; has dimensions of (l, d), as follows.

Dimensional Attention Matrix for mᵢ=Distance(q_{i,}k_{[0,k]}) (6)

Here, qᵢ represents the representation of the i^{th} query token, and k_{[0,k]} represents the representation of the k^{th} key token.

It is also or alternatively possible to incorporate dimensional embeddings directly into the generation of the query, key, and value matrices. This may be viewed as being similar to (but distinct from) positional embeddings. Positional embeddings are generally used to hold information about the position of a token in a sentence. In contrast, dimensional embeddings can be used to hold information about the position of a dimension optimized within a token. Such dimensional embeddings can be added to the query, key, and value matrices, which results in the generation of attention weights that are more attuned to dimensional-level information when regular attention is performed In some cases, these operations may be expressed as follows.

Attention_{l,t}(Q, K, V)=SoftMax(QK^{T})V (7)

Q=e_{l-1,t}w_{l,t}^{Q}+DimensionalEmbedding (8)

K=e_{l-1,t}w_{l,t}^{K}+DimensionalEmbedding (9)

V=e_{l-1,t}w_{l,t}^{V}+DimensionalEmbedding (10)

In Equations (8)-(10), the term to the left of the plus sign on the right side of each equation represents the linear projection performed by the corresponding linear projections 204, 254 described above, which are based on input embeddings e_{l-1,t}. The term to the right of the plus sign on the right side of each equation represents a dimensional embedding term that identifies a position of a dimension within a token. In other embodiments, the dimensional embeddings may be incorporated directly into the input embeddings e_{l-1,t} themselves. In some cases, this may be expressed as follows.

e_{l-1,t}=e_{l-1,t}+DimensionalEmbedding (11)

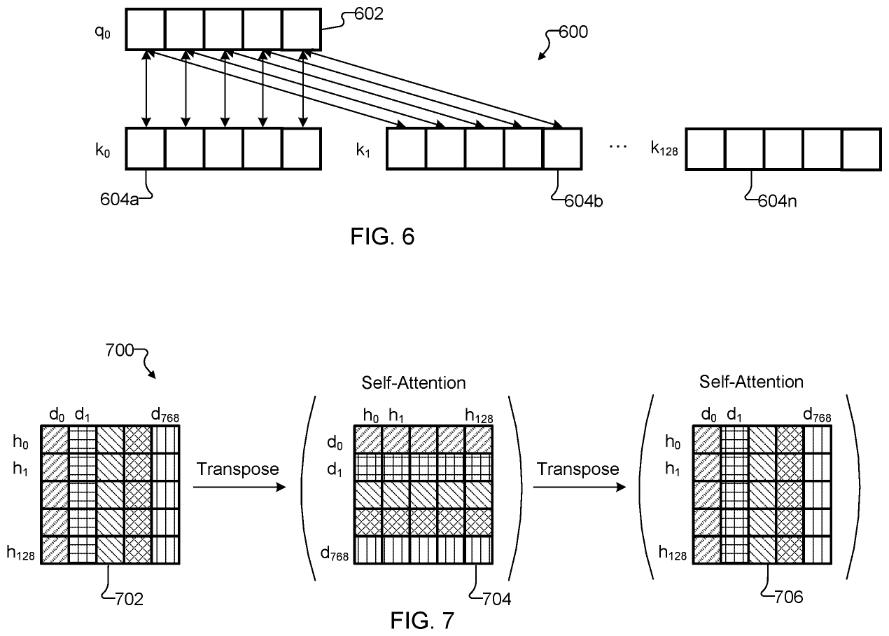

FIG. 7 illustrates yet another example approach 700 for providing dimensional attention for weight allocation in language models or other machine learning models according to this disclosure. For example, FIG. 7 illustrates a specific example for providing dimensional attention that may be implemented using various ones of the functions 206-212 shown in FIG. 2A. In some cases, this approach for providing dimensional attention may be used within a single attention head (such as the one shown in FIG. 2A) or in multiple attention heads (such as the ones shown in FIG. 2B).

As shown in FIG. 7, a matrix 702 represents a token embedding matrix, which means that the matrix 702 is formed using the embeddings of multiple tokens. In this example, the token embeddings are arranged vertically, so each column of the matrix 702 represents the embedding for a different token. In this particular example, the matrix 702 includes multiple tokens indexed using values between zero and 128, and each token includes dimensions indexed using values between zero and 768 (although these dimensions are examples only and can vary as needed or desired).

The matrix 702 undergoes a first transpose operation to produce a transposed matrix 704, which in this example means that each row of the matrix 702 represents the embedding for a different token. A first self-attention operation is performed, which is used to perform dimensional-level mixing of the features of the tokens. The first self-attention operation effectively provides information regarding which dimensions of the embeddings are more or less important. Another transpose operation is used to convert the output of the first self-attention operation into a matrix 706, and a second self-attention operation is performed using the matrix 706, which is used to perform token-level mixing of context. The second self-attention operation is applied at the token-level and provides information regarding which tokens are more or less important. This approach 700 can leverage an existing self-attention mechanism but use the self-attention mechanism twice to perform two different self-attention operations. This approach 700 implicitly adds granular self-attention through mixing of dimensional-level embeddings followed by regular attention. Note that while this example performs two transpose operations, the approach 700 may be modified to operate in other ways. For example, the token embedding matrix may initially be created to have the form of the matrix 704, in which case a single transpose operate may be performed to produce the matrix 706.

In the example shown in FIG. 7, the two self-attention operations are performed sequentially. However, other approaches may perform the two self-attention operations in parallel, which may enable improvements in the granularity of the overall attention operation in some cases. As a particular example, the first self-attention operation performed across the dimensions of the embeddings may include the following operations.

Dimensional Query=eₗ₋₁^{T}W_{l,t}^{Q}^{_{D}} (12)

Dimensional Key=eₗ₋₁^{T}W_{l,t}^{K}^{_{D}} (13)

Dimensional Attention Weights=(Dimensional Query)·(Dimensional Key) (14)

The second self-attention operation performed across the dimensions of the tokens may include the following operations.

Query=eₗ₋₁^{T}W_{l,t}^{Q} (15)

Key=eₗ₋₁^{T}W_{l,t}^{K} (16)

Regualar Attention Weights=(Query)·(Key) (17)

Final Attention Weights=(Dimensional Attention Weights)^{T}*(Regular Attention Weights) (18)

These operations generate an attention matrix having dimensions of (m, d, d). Operations similar to those discussed above may be used to calculate the embeddings for layer (l−1), and dimensional attention weights and regular attention weights can be generated in parallel (rather than sequentially as in FIG. 7).

Note that any of the approaches for providing dimensional attention for weight allocation described above may be used within a single attention head (such as the one shown in FIG. 2A) or in multiple attention heads (such as the ones shown in FIG. 2B). When implemented within multiple attention heads, each attention head may operate to produce an output embedding Eᵢ for each token associated with an input, and the attention heads may operate in parallel. The multiple output embeddings Eᵢ for each token can be combined and processed using the linear projection or pooling function 260, which generates a single output embedding of dimension m for each token.

Although FIGS. 3 through 7 illustrate examples of approaches for providing dimensional attention for weight allocation in language models or other machine learning models, various changes may be made to FIGS. 3 through 7. For example, the specific matrices and vectors shown in FIGS. 3 through 7 are for illustration only. The actual numbers and dimensions of the matrices and vectors may vary from those shown in FIGS. 3 through 7.

It should be noted that the functions shown in or described with respect to FIGS. 2A through 7 can be implemented in an electronic device 101, 102, 104, server 106, or other device in any suitable manner. For example, in some embodiments, at least some of the functions shown in or described with respect to FIGS. 2A through 7 can be implemented or supported using one or more software applications or other software instructions that are executed by the processor 120 of the electronic device 101, 102, 104, server 106, or other device. In other embodiments, at least some of the functions shown in or described with respect to FIGS. 2A through 7 can be implemented or supported using dedicated hardware components. In general, the functions shown in or described with respect to FIGS. 2A through 7 can be performed using any suitable hardware or any suitable combination of hardware and software/firmware instructions. Also, the functions shown in or described with respect to FIGS. 2A through 7 can be performed by a single device or by multiple devices.

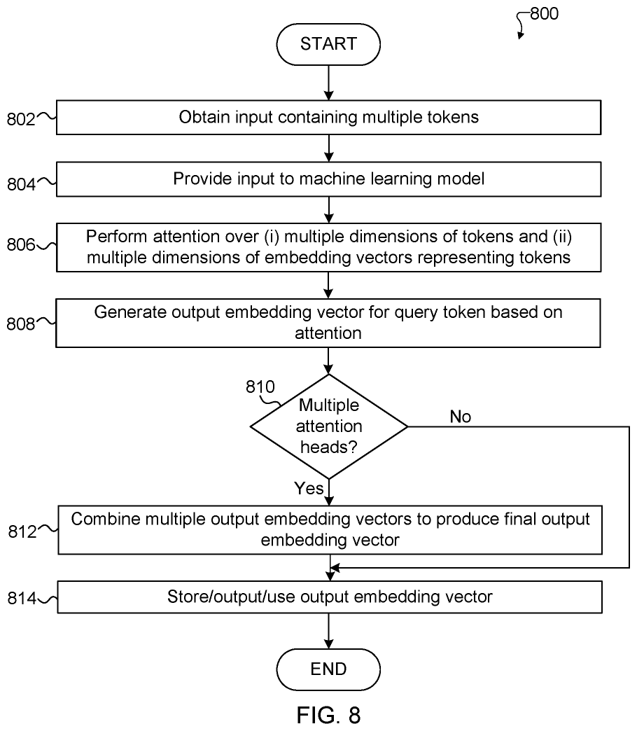

FIG. 8 illustrates an example method 800 for providing dimensional attention for weight allocation in language models or other machine learning models according to this disclosure. For ease of explanation, the method 800 shown in FIG. 8 is described as being performed by the electronic device 101 in the network configuration 100 of FIG. 1. However, the method 800 shown in FIG. 8 could be used with any other suitable device(s), such as the server 106, and in any other suitable system(s).

As shown in FIG. 8, an input containing multiple tokens is obtained at step 802. This may include, for example, the processor 120 of the electronic device 101 obtaining an input sentence or other input text containing tokens in the form of words/parts of words. The input may be obtained via a microphone of the electronic device 101, a virtual keyboard of the electronic device 101, or in any suitable manner. The input is provided to a machine learning model at step 804. This may include, for example, the processor 120 of the electronic device 101 providing the tokens of the input to a transformer-based machine learning model 200 or 250 for processing.

During processing of the input, attention is performed over both (i) multiple dimensions of the tokens contained in the input and (ii) multiple dimensions of embedding vectors used to represent the tokens at step 806. This may include, for example, the processor 120 of the electronic device 101 using any of the techniques described above to perform attention over the dimensions of the tokens and over the dimensions of the embedding vectors that represent the tokens. In some embodiments, performing the attention may include, for each token contained in the input, generating an embedding vector that represents the token, generating a query representation by multiplying the embedding vector with a query matrix, generating a key representation by multiplying the embedding vector with a key matrix, and generating a value representation by multiplying the embedding vector with a value matrix. Performing the attention may also include, for a specific token (which may be referred to as a query token), generating attention weight vectors based on the query representation associated with the query token and the key representations associated with the tokens, applying a softmax function to the attention weight vectors in order to generate modified attention weight vectors, and generating weighted value vectors by multiplying the value representations and the modified attention weight vectors.

An output embedding vector is generated based on a sum of the weighted value vectors at step 808. This may include, for example, the processor 120 of the electronic device 101 combining the weighted value vectors to generate an output embedding vector Eᵢ for the query token or other token. If there is a single attention head in the machine learning model, the output embedding vector Eᵢ can be used as the final output embedding vector for that token. If there are multiple attention heads in the machine learning model at step 810, multiple output embedding vectors from the multiple attention heads are combined to produce a final output embedding vector for a token at step 812. This may include, for example, the processor 120 of the electronic device 101 combining the output embedding vectors Ei from the attention heads, such as via linear projection or pooling, to produce a final output embedding vector Eᵢ for the query token or other token.

The output embedding vector is stored, output, or used in some manner at step 814. This may include, for example, the processor 120 of the electronic device 101 passing the output embedding vector Eᵢ for the query token or other token to a subsequent layer of a machine learning model or to a different machine learning model for further processing. As particular examples, the output embedding vector Eᵢ for the query token or other token may be provided to at least one layer of a large language model for use in understanding the input and possibly generating a response to the input.

Although FIG. 8 illustrates one example of a method 800 for providing dimensional attention for weight allocation in language models or other machine learning models, various changes may be made to FIG. 8. For example, while shown as a series of steps, various steps in FIG. 8 may overlap, occur in parallel, occur in a different order, or occur any number of times.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining an input containing multiple tokens;
processing the input using a machine learning model, wherein processing the input comprises performing attention over both (i) multiple dimensions of the tokens contained in the input and (ii) multiple dimensions of embedding vectors used to represent the tokens contained in the input so that different dimensions of each of at least some of the tokens are weighted differently; and
generating an output embedding vector for a query token of the multiple tokens based on the attention.

2. The method of claim 1, wherein performing the attention comprises:
for each of the tokens contained in the input:
generating one of the embedding vectors that represents the token; and
generating a query representation by multiplying the embedding vector with a query matrix, a key representation by multiplying the embedding vector with a key matrix, and a value representation by multiplying the embedding vector with a value matrix; and
for the query token:
generating attention weight vectors based on the query representation associated with the query token and the key representations associated with the tokens;
applying a softmax function to the attention weight vectors in order to generate modified attention weight vectors, and
generating weighted value vectors by multiplying the value representations and the modified attention weight vectors, the output embedding vector for the query token based on a sum of the weighted value vectors.

3. The method of claim 2, wherein at least one of:
each query representation includes a different query vector for each of multiple dimensions; and
each key representation includes a different key vector for each of multiple dimensions.

4. The method of claim 2, wherein generating the attention weight vectors comprises determining a distance or similarity between (i) the query representation associated with the query token and (ii) each of the key representations associated with the tokens.

5. The method of claim 2, wherein each of the query representations, key representations, and value representations includes or is associated with a dimensional embedding, the dimensional embedding identifying one of the dimensions associated with one of the tokens.

6. The method of claim 2, wherein performing the attention comprises:
performing dimensional-level mixing of features based on a transpose of a token embedding matrix using a first self-attention operation, the token embedding matrix containing the embedding vectors of the tokens; and
performing token-level mixing of context based on a transpose of results of the first self-attention operation using a second self-attention operation.

7. The method of claim 2, wherein:
performing the attention comprises performing dimensional-level mixing of features and token-level mixing of context based on a token embedding matrix using first and second self-attention operations, the token embedding matrix containing the embedding vectors of the tokens;
the first and second self-attention operations are performed in parallel; and
a transpose of results of one of the first and second self-attention operations is multiplied by results of another of the first and second self-attention operations to generate final attention weights.

8. The method of claim 2, wherein:
the machine learning model comprises multiple attention heads;
each attention head is configured to generate an output embedding vector for each token; and
the method further comprises using the output embedding vectors associated with each token to generate a single output embedding for the token.

9. An electronic device comprising:
at least one processing device configured to:
obtain an input containing multiple tokens;
process the input using a machine learning model, the machine learning model configured to perform attention over both (i) multiple dimensions of the tokens contained in the input and (ii) multiple dimensions of embedding vectors used to represent the tokens contained in the input so that different dimensions of each of at least some of the tokens are weighted differently; and
generate an output embedding vector for a query token of the multiple tokens based on the attention.

10. The electronic device of claim 9, wherein, to perform the attention, the machine learning model is configured to:
for each of the tokens contained in the input:
generate one of the embedding vectors that represents the token; and
generate a query representation by multiplying the embedding vector with a query matrix, a key representation by multiplying the embedding vector with a key matrix, and a value representation by multiplying the embedding vector with a value matrix; and
for the query token:
generate attention weight vectors based on the query representation associated with the query token and the key representations associated with the tokens;
apply a softmax function to the attention weight vectors in order to generate modified attention weight vectors; and
generate weighted value vectors by multiplying the value representations and the modified attention weight vectors, the output embedding vector for the query token based on a sum of the weighted value vectors.

11. The electronic device of claim 10, wherein at least one of:
each query representation includes a different query vector for each of multiple dimensions; and
each key representation includes a different key vector for each of multiple dimensions.

12. The electronic device of claim 10, wherein, to generate the attention weight vectors, the at least one processing device is configured to determine a distance or similarity between (i) the query representation associated with the query token and (ii) each of the key representations associated with the tokens.

13. The electronic device of claim 10, wherein each of the query representations, key representations, and value representations includes or is associated with a dimensional embedding, the dimensional embedding identifying one of the dimensions associated with one of the tokens.

14. The electronic device of claim 10, wherein, to perform the attention, the machine learning model is configured to:
perform dimensional-level mixing of features based on a transpose of a token embedding matrix using a first self-attention operation, the token embedding matrix containing the embedding vectors of the tokens; and
perform token-level mixing of context based on a transpose of results of the first self-attention operation using a second self-attention operation.

15. The electronic device of claim 10, wherein:
to perform the attention, the machine learning model is configured to perform dimensional-level mixing of features and token-level mixing of context based on a token embedding matrix using first and second self-attention operations, the token embedding matrix containing the embedding vectors of the tokens;
the machine learning model is configured to perform the first and second self-attention operations in parallel; and
the machine learning model is configured to multiply a transpose of results of one of the first and second self-attention operations by results of another of the first and second self-attention operations to generate final attention weights.

16. The electronic device of claim 10, wherein:
the machine learning model comprises multiple attention heads;
each attention head is configured to generate an output embedding vector for each token; and
the at least one processing device is further configured to use the output embedding vectors associated with each token to generate a single output embedding for the token.

17. A non-transitory machine readable medium containing instructions that when executed cause at least one processor of an electronic device to:
obtain an input containing multiple tokens;
process the input using a machine learning model, the machine learning model configured to perform attention over both (i) multiple dimensions of the tokens contained in the input and (ii) multiple dimensions of embedding vectors used to represent the tokens contained in the input so that different dimensions of each of at least some of the tokens are weighted differently; and
generate an output embedding vector for a query token of the multiple tokens based on the attention.

18. The non-transitory machine readable medium of claim 17, wherein the instructions that when executed cause the at least one processor to perform the attention comprise instructions that when executed cause the at least one processor to:
for each of the tokens contained in the input:
generate one of the embedding vectors that represents the token; and
generate a query representation by multiplying the embedding vector with a query matrix, a key representation by multiplying the embedding vector with a key matrix, and a value representation by multiplying the embedding vector with a value matrix; and
for the query token:
generate attention weight vectors based on the query representation associated with the query token and the key representations associated with the tokens;
apply a softmax function to the attention weight vectors in order to generate modified attention weight vectors; and
generate weighted value vectors by multiplying the value representations and the modified attention weight vectors, the output embedding vector for the query token based on a sum of the weighted value vectors.

19. The non-transitory machine readable medium of claim 17, wherein the instructions that when executed cause the at least one processor to perform the attention comprise instructions that when executed cause the at least one processor to:
perform dimensional-level mixing of features based on a transpose of a token embedding matrix using a first self-attention operation, the token embedding matrix containing the embedding vectors of the tokens; and
perform token-level mixing of context based on a transpose of results of the first self-attention operation using a second self-attention operation.

20. The non-transitory machine readable medium of claim 17, wherein:
the machine learning model comprises multiple attention heads;
each attention head is configured to generate an output embedding vector for each token; and
the non-transitory machine readable medium further contains instructions that when executed cause the at least one processor to use the output embedding vectors associated with each token to generate a single output embedding for the token.
